(19) United States
(12) Patent Application Publication
(10) Pub. No.: US 2025/0026203 A1
(43) Pub. Date: Jan. 23, 2025

(54) BATTERY-POWERED ELECTRIC POWER SOURCE PLATFORM

(71) Applicant: Meridian Manufacturing Inc., Sunnyside (CA)

(72) Inventors: Samuel J. PLETT, Sunnyside (CA); Glenn Delbert FRIESEN, Sunnyside (CA)

(21) Appl. No.: 18/353,147

(22) Filed: Jul. 17, 2023

(51) Int. Cl. B60L 1/00; B60L 50/60; B65G 41/00

(52) U.S. Cl. CPC B60L 1/003; B60L 50/60; B65G 41/002; B65G 41/008; B60L 2200/40; B65G 2201/042

(57) ABSTRACT

The disclosure relates to battery-powered electrical power source systems that may be configured to equipment. The systems are configured to provide power for a primary function of the equipment such as conveying material and for other functions such as moving and steering the equipment. The systems described are particularly suited to be configured to short-line agricultural equipment such as portable augers/conveyors.

### FIELD

The disclosure relates to battery-powered electrical power source systems that may be configured to equipment. The systems are configured to provide power for a primary function of the equipment such as conveying material and for other functions such as moving and steering the equipment. The systems described are particularly suited to be configured to short-line agricultural equipment such as portable augers/conveyors.

### BACKGROUND

Short-line agricultural equipment, such as augers, conveyors, and seed tenders, are traditionally powered with gasoline or diesel engines. These internal combustion engines (ICEs) can be highly effective in providing power to such equipment. However, in many situations, there are a number of problems associated with the use of such engines.

For example, certain jurisdictions have banned or are in the process of banning small internal combustion engines with various types of equipment because of the carbon emissions from the ICEs and the contribution that many small ICE's may make to an industry's overall emissions.

In addition, it is known that equipment having ICEs, such as short-line agricultural equipment may be operated indoors, where the exhaust gases can become dangerous to operators, bystanders and/or animals particularly if the enclosed indoor space has poor ventilation.

Further still, the use of ICEs with some equipment is not efficient, particularly in situations where the nature of the job is intermittent. In these situations, it is often the practice of an operator to leave an ICE idling for a period of time between sessions of use which not only creates exhaust gases but is wasteful of fuel.

Previous attempts to overcome these problems have included the use of electrically operated systems that are plugged into wall outlets. While addressing the problem of exhaust gases, there are various operational problems with such systems including limiting or preventing use of the equipment. Such limitations can include not being able to move/operate the equipment to/at distances greater than the length of the electrical cord and/or requiring the use of vehicles such as trucks or tractors to tow or trailer the equipment to a desired location. In either case, this increases the time and complexity of moving equipment but may also end up with a vehicle engine being operated for at least some period within an un-ventilated or poorly ventilated space. Further, the source of electricity via an extension/power cord requires a mains power supply in relatively close proximity to the desired location of operation of the equipment.

Accordingly, there is a need for improvement in the operation of short-line agricultural equipment particularly in indoor applications.

### SUMMARY

In accordance with the disclosure, there is provided a power and control system for configuration to equipment to provide operative power to the equipment having: a control system having a user interface for providing input to the control system, the control system configured to: at least one power output system; a power source motor configured to direct power through the control system to the at least one power output system; and, a battery configured to power the power source motor; wherein the control system, user interface, power source motor, power output system and battery are configured to a frame for selective connection to the equipment and wherein once connected, the frame is supported and moveable with the equipment and wherein the equipment is operable by a user through the user interface.

In various embodiments:
the power source motor is a hydraulic motor and the at least one power output system is at least two power output systems including a combination of rotary power output and hydraulic fluid output.
the equipment is supported by a wheel system and at least one power output system is configured to provide motive power to at least one axle motor configured to the wheel system.
the equipment is supported by a wheel system having a steering system and the at least one power output system is configured to provide motive power to the steering system.
the power source motor is an electric motor.

In another aspect, the disclosure provides a system having: an input hopper, product lifting system and discharge end supported on a frame having a wheel system; a portable power system (PPS) pivotally connected to the frame, the PPS supporting a battery, a power system and an input system wherein: the battery supplies power to the power system; the power system includes: a first power output system configured to the product lifting system; a second power output system configured to the wheel system; and, the input system is configured to enable an operator to activate the first and second power output systems.

In various embodiments, the system includes:
a third power output system configured a steering system configured to the wheel system and the input system is configured to enable an operator to activate the third power output system.
a fourth power output system configured to the product lifting system to rotate the product lifting system relative to a horizontal axis.
a fifth power output system configured to the input hopper to rotate the input hopper system relative to a horizontal axis.
the power system and battery system include a charge controller, a motor controller and an electric motor and hydraulic power system configured to provide hydraulic power to each of the first, second, third, fourth and fifth power output systems.

### BRIEF DESCRIPTION OF THE DRAWINGS

Various objects, features and advantages of the disclosure will be apparent from the following description of particular embodiments of the disclosure, as illustrated in the accompanying drawings. The drawings are not necessarily to scale, emphasis instead being placed upon illustrating the principles of various embodiments of the disclosure. Similar reference numerals indicate similar components.

FIG. 1 is a perspective view of a portable conveyor system configured with support wheels and a power system, according to one embodiment.

FIG. 2 is a front perspective of a power system according to one embodiment.

FIG. 3 is a side view of a power system with a hydraulic output motor according to one embodiment.

FIG. 3A is a top view of a power system with a hydraulic output motor according to one embodiment.

FIG. 4 is a schematic diagram of a hydraulic power supply system according to one embodiment.

FIGS. 5 and 5A are schematic diagrams showing generalized layouts of a power system according to various embodiments.

### DETAILED DESCRIPTION

Various aspects of the disclosure will now be described with reference to the figures. For the purposes of illustration, components depicted in the figures are not necessarily drawn to scale. Instead, emphasis is placed on highlighting the various contributions of the components to the functionality of various aspects of the disclosure. A number of possible alternative features are introduced during the course of this description. It is to be understood that, according to the knowledge and judgment of persons skilled in the art, such alternative features may be substituted in various combinations to arrive at different embodiments of the present disclosure.

Referring to the Figures, power systems 100 for providing battery power to associated equipment such as short-line agricultural equipment 200 are described. In this description, reference is made to portable conveyor or auger systems used for agricultural applications. It is however to be understood that the power systems described may be configured to a variety of equipment where ICE power can be replaced with various forms of electrically derived energy.

### Overview

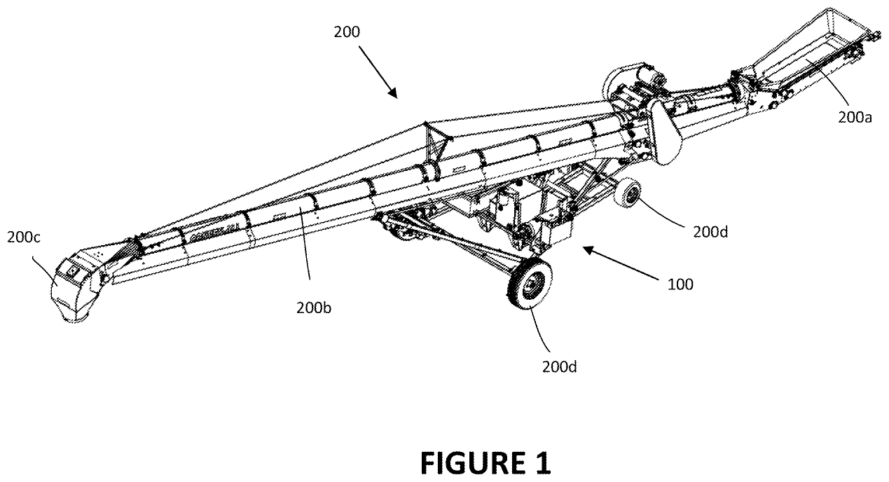

As shown in FIGS. 1-3, the portable power system (PPS) 100 is a self-contained system that can be operatively configured to equipment to supply power that may otherwise be supplied by an ICE. Generally, the PPS 100 includes a cradle 12 having horizontal support 12a, hangers 12b and one or more flanges 12c to connect the PPS to an existing frame 200e of the equipment. The PPS 100 further includes an operator input system 10 having for example levers 10a, 10b enabling operator input to operate the equipment as well as a battery system 14 and a power system 16.

### Cradle 12

As noted, the cradle includes a horizontal support 12a with vertical arms 12a′ that may be configured with one or more trays 12d supported by hangers 12b and pivotally connected to vertical arms 12a′ that in combination support each of the PPS sub-systems. Vertical partitions/members 12e, 12f may be provided to enable each sub-system to be secured to the cradle and allow different sub-systems of different sizes to be removed and secured to the cradle. Hangers 12b enable the PPS to pivot to ensure the PPS remains substantially horizontal during use/operation particularly when used with equipment that may tilt.

Flanges 12c may be configured to appropriate locations of the non-swinging portions of the cradle to enable connection to an existing frame 100a of equipment 200. Components/sub-systems are generally configured to the cradle 12 in an orientation to provide ease of operation for an operator and to provide ease of access to components for replacement and/or maintenance.

### Battery System 14 and Power System 16

The battery system 14 includes a battery box 14a containing a main battery (not shown) and a smaller battery 14a′. The power system 16 receives electrical power from the battery system and converts the electrical energy to usable power to operate the equipment including both primary and secondary functions. Generally, the main battery provides power to the power system where the smaller battery provides power to the various electrical circuits of the PPS that may be required to activate the system and its various sub-systems.

In various embodiments, components of the battery and power systems include a charge controller 14b, motor controller 14c, motor 14d, DC/DC converter 14f and fan 14e mounted to panel 12e adjacent the battery box 14a. The charge controller generally functions to receive AC mains power, convert AC power to DC power and control main battery charging. Depending on configuration, the DC/DC converter may be utilized to step down main battery voltage to enable charging of the smaller battery by the main battery. The motor controller supplies power to the motor 14d. Fan 14e is configured adjacent the motor controller and is typically activated in response to a temperature limit being reached in the motor controller.

Other components of the battery system may include switches/meters 10c displaying various battery parameters and charging port 10d allowing connection to AC power. Generally, all components are configured to provide appropriate ventilation for heat management within the system. That is, components where high electrical currents are being generated/used are typically configured towards the exterior of the system and/or configured with a fan and/or to separate panels to enhance cooling of such components as may be required.

As noted, the power system 16 delivers electric power from the main battery to motor 14d which converts that power to rotational energy and/or linear energy. In one embodiment, the power system is a hydraulic system having an electrically powered hydraulic pump for pressurizing and moving hydraulic fluid to actuate hydraulic motors and/or cylinders. In other embodiments, one or more electric motors are configured within the power system to create rotational and/or linear energy.

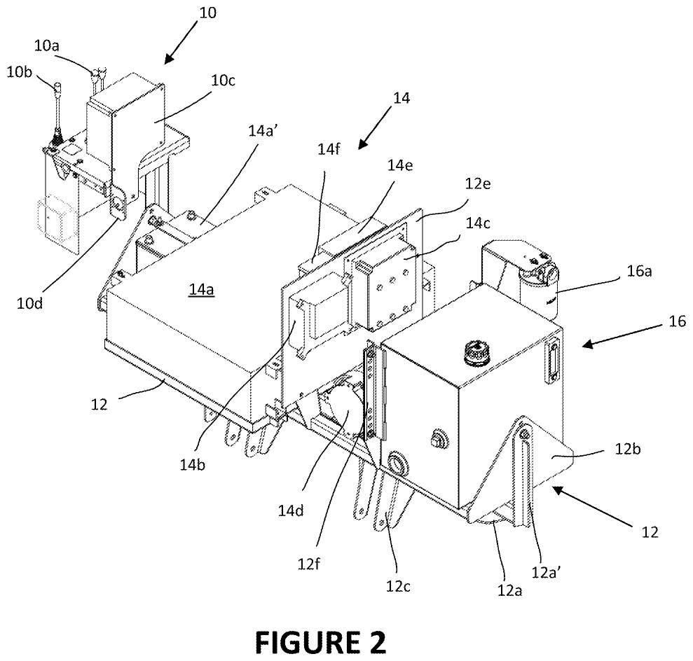

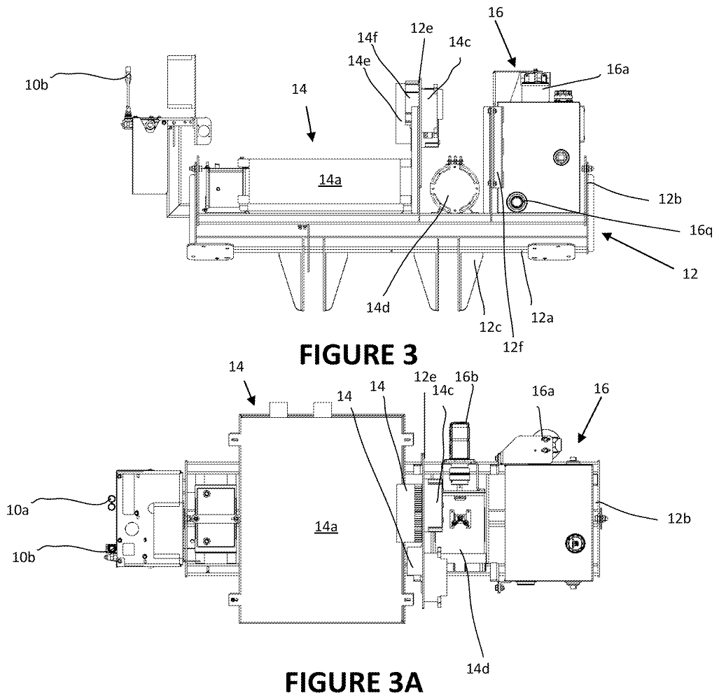

As shown in FIGS. 2-3A, the power system is a hydraulic system configured to appropriate hydraulic control lines that will be explained in greater detail below. For the purposes of clarity, electric and hydraulic cables are not shown in these Figures. The power system includes at least one power output such as a rotary output that may be configured to the equipment. The power output may provide such functions as rotary power to a shaft, pulley system, gearbox, or input to hydraulic motors or hydraulic cylinders configured to the equipment 200. Typically, the power output is not configured to the components mounted to the cradle but is connected to specific systems on the equipment by one or more hydraulic cables or electrical cables to the cradle-mounted components.

The power system may also provide hydraulic or electric power to a steering system and wheel drive system.

As shown in FIG. 3A, hydraulic motor 16b is preferably configured directly to motor 14d.

### Example Conveyor System 100

As shown in FIG. 1, the equipment may be a conveyor system 200 connected to the portable power system 100 via appropriate connections. As shown, a typical conveyor system includes an input conveyor/hopper 200a, auger tube 200b, discharge end 200c mounted to wheels 200d through frame 200e. The conveyor system may also include appropriate pivots and cylinders allowing an operator to lift and lower the auger tube and input conveyor/hopper during use and/or for transportation. The wheels of the conveyer system may include a drive and steering system configured to the wheels and their axles to both move and steer the conveyor system. Each of the input conveyer, lifting system and drive/steering system may have independently controlled motors/actuators.

In operation, the conveyor system can be driven to a location where, for example, it is desired to move grain from a bin into a truck for transport to a grain elevator. In this example, the operator may drive the conveyor system to the bin and position the input conveyor at the output end of the bin. The auger tube may be lifted to position the discharge end at a height and position to fill a truck and the input conveyor/hopper system similarly adjusted to receive grain. Grain is fed to the input conveyer/hopper where it is carried to the auger tube to the discharge end and into the truck. In this example, the power system provides power to each of the input conveyer, auger tube, wheels, steering system and linear actuation system for positioning the auger tube.

In this example, the power system is configured in a transverse orientation on the frame 100a of the conveyor system and between the wheels 200b. The control system 10 is located on an outer or distal edge of the power system to allow users to access and operate the controls away from moving parts to reduce the risk for injury to the user while the conveyor is being moved.

### Hydraulic Control System 16

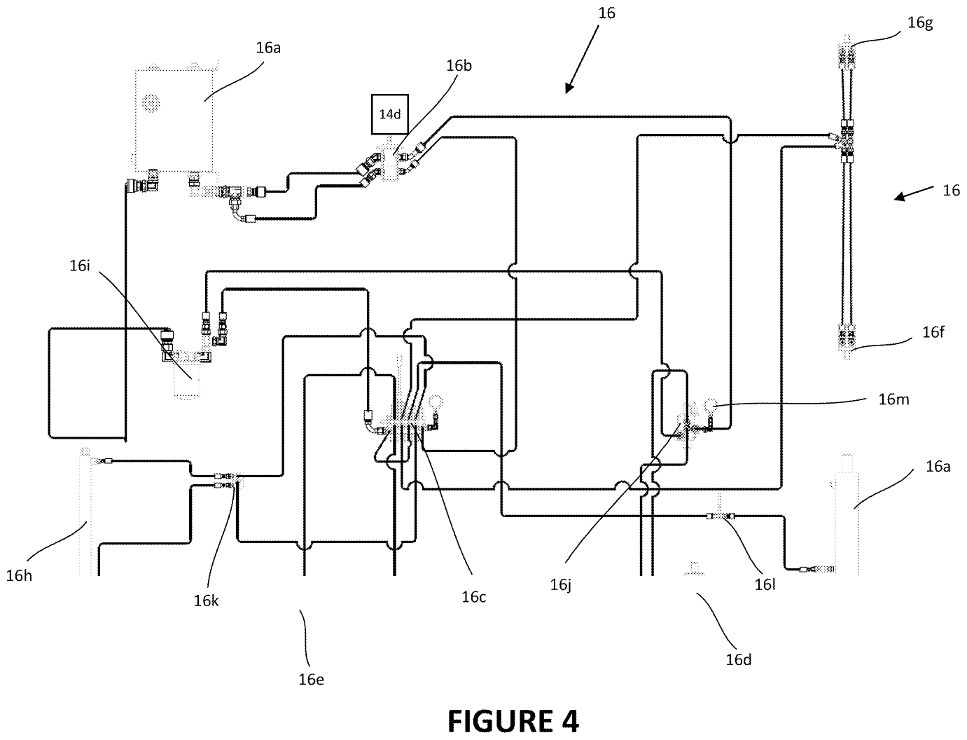

Turning to FIG. 4, a representative hydraulic control system is described that provides output power to each of the above systems including power for the conveyor/hopper, auger tube, steering, drive and lifting systems.

In the embodiment shown in FIG. 4, the hydraulic system 16 includes a hydraulic pump 16b, reservoir 16i, input/control systems 16c, 16m, output motor 16d, lifting cylinder 16e, wheel motors 16f, 16g and hopper cylinder 16h. The system also includes hydraulic oil filter 16a and output gauges 16m all interconnected by appropriate hydraulic lines and valves.

In this embodiment, electric power is delivered to hydraulic pump 16b by motor 14d to provide high-pressure hydraulic fluid/flow to the hydraulic system. The operator, through the input/control system 16c, 16j, can selectively direct hydraulic fluid to specific sub-systems to move and operate the system. For example, an operator may initially activate the wheel motors 16f, 16g and steering cylinder 16e to move the system 100 into a desired location. The wheel motors may be operated at the same speed in forward or reverse directions or at different speeds to assist in turning, depending on the configuration, and/or steering may be affected by the steering cylinder.

Once in position, the operator may then activate the hopper cylinder 16h to orient the hopper and adjust the angle and height of the auger tube via cylinder 16e. Once the auger tube is in position, motor 16d may be turned on to activate the auger tube and hopper.

The hydraulic system is configured with appropriate flow circuits to receive and return hydraulic fluid to/from the reservoir 16a and to actuate configured hydraulic motors or cylinders. Generally, each power system has an independent flow circuit that may include safety check valves 16k, 161 which prevent cylinders 16h, 16a from draining and collapsing in the event of a hose leak.

In various embodiments, the power system 100 is configured to allow different components of the system to be interconnected with one another to provide flexibility in the functionality of a system based on the requirements of the connected equipment. For example, one model of a conveyor system may have manually operable systems for orienting an auger tube such that power systems are not required to lift and lower an auger tube. Accordingly, the power system 100 of the disclosure can be configured such that hydraulic lines are connected to a base system (e.g. a hydraulic control valve system having a multitude of hydraulic ports) if additional functionality is required for a particular piece of equipment.

Accordingly, it is desirable that battery packs and control lines can be connected and disconnected from other components depending on a specific application through readily accessible connectors. As shown in FIG. 3, hydraulic connectors 16q may be configured to the hydraulic system such that appropriate hydraulic hoses can be connected.

Further, depending on the application, embodiments of the power system will or will not require weatherproofing depending on whether the predominant use is indoors or outdoors. In one embodiment, electrical connectors for cabling are located on the underside of the PPS.

In some embodiments, the power system 100 is configured with solar panels (not shown) to enable passive charging to the battery.

According to an alternative embodiment of the disclosure, all drive systems are electric and operated without the use of hydraulics. The system may be further configured with controls such as a hopper cylinder and an undercarriage cylinder to provide control to various components, such as a hopper and undercarriage, where liner positioning of configuring equipment may be required.

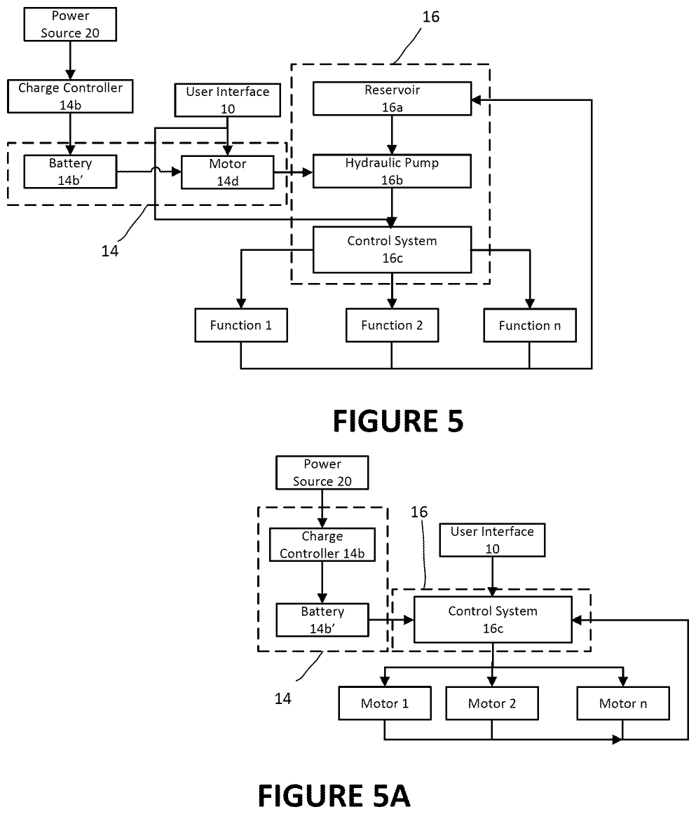

FIGS. 5 and 5A show generalized layouts of a power system in accordance with hydraulic and non-hydraulic system with selectively configurable outputs.

FIG. 5 shows a hydraulic power system with a user interface 10, battery system 14, hydraulic system 16 that supplies power for 1-n functions. Battery 14b′ may be charged by power source 20 through charge controller 14b. An operator can activate and operate the system through user interface 10. The hydraulic system with reservoir 16a, hydraulic pump 16b and control system 16c allows one or more pumps/actuators to be connected to provide output functions.

FIG. 5A shows an electric power system with a user interface 10, battery system 14, control system 16c that supplies power to 1-n motors. Battery 14b′ may be charged by power source 20 through charge controller 14b. Each motor may include sensors/feedback to the control system 16c.

Although the present disclosure has been described and illustrated with respect to preferred embodiments and preferred uses thereof, it is not to be so limited since modifications and changes can be made therein which are within the full, intended scope of the disclosure as understood by those skilled in the art.

1. A power and control system for configuration to equipment to provide operative power to the equipment comprising:
a control system having a user interface for providing input to the control system, the control system configured to:
at least one power output system;
a power source motor configured to direct power through the control system to the at least one power output system; and,
a battery configured to power the power source motor;
wherein the control system, user interface, power source motor, power output system and battery are configured to a frame for selective connection to the equipment and wherein once connected, the frame is supported and moveable with the equipment and wherein the equipment is operable by a user through the user interface.

2. The system of claim 1, wherein the power source motor is a hydraulic motor and the at least one power output system is at least two power output systems including a combination of rotary power output and hydraulic fluid output,

3. The system of claim 2, wherein the equipment is supported by a wheel system and at least one power output system is configured to provide motive power to at least one axle motor configured to the wheel system.

4. The system of claim 2, wherein the equipment is supported by a wheel system having a steering system and the at least one power output system is configured to provide motive power to the steering system.

5. The system of claim 1, wherein the power source motor is an electric motor.

6. A system comprising:
a granular material moving system supported on a frame having a wheel system;
a portable power system (PPS) pivotally connected to the frame, the PPS supporting a battery, a power system and an input system wherein:
the battery supplies power to the power system;
the power system includes:
a first power output system configured to the granular material moving system;
a second power output system configured to the wheel system; and,
the input system is configured to enable an operator to activate the first and second power output systems.

7. The system as in claim 6 further comprising a third power output system configured a steering system configured to the wheel system and the input system is configured to enable an operator to activate the third power output system.

8. The system as in claim 7 further comprising a fourth power output system configured to the granular material moving system to rotate the granular material moving system relative to a horizontal axis.

9. The system as in claim 8, wherein the system includes a product input system and the system further comprises a fifth power output system configured to the input system to rotate the product input system relative to a horizontal axis.

10. The system as in claim 9, wherein the power system and battery system include a charge controller, a motor controller and an electric motor and hydraulic power system configured to provide hydraulic power to each of the first, second, third, fourth and fifth power output systems.

11. The system as in claim 6, wherein the input system, battery system and power system are linearly separated and positioned on at least one tray pivotally connected to the frame and wherein the input system and power system are outboard of the battery system on the tray.
